(19) United States
(12) Patent Application Publication
(10) Pub. No.: US 2007/0142084 A1
(43) Pub. Date: Jun. 21, 2007

(54) APPARATUS AND METHOD FOR DETERMINING A DEVICE CONNECTED TO A RADIO COMMUNICATION TERMINAL

(75) Inventors: Sabine Van Niekerk, Salzgitter-Lebensted (DE); Norbert Schwagmann, Braunschweig (DE); Achim Luft, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/561,597

(22) Filed: Nov. 20, 2006

Related U.S. Application Data
(60) Provisional application No. 60/739,305, filed on Nov. 23, 2005.

(51) Int. Cl. H04B 1/38

(52) U.S. Cl. 455/557; 340/7.54; 455/558

(57) ABSTRACT

A radio communication device including a radio communication terminal and a chip card. The radio communication terminal includes a generation unit generating device information which specifies for at least one device if the device is coupled to the radio communication terminal, and a transmitting unit transmitting the device information to the chip card.

### CROSS-REFERENCE TO RELATED APPLICATIONS

This application claims priority to provisional patent application Ser. No. 60/739,305, which was filed on Nov. 23, 2005, and is incorporated herein by reference in its entirety.

### FIELD OF THE INVENTION

The invention relates to a radio communication device, a method for controlling a chip card, a radio communication terminal, a chip card and a method for operating a chip card.

### BACKGROUND OF THE INVENTION

In a mobile communication system according to the UMTS (Universal Mobile Telecommunications System) Standard a mobile radio user device is called UE (user equipment) and consists of a mobile phone (the so-called mobile equipment ME) and a UICC (Universal Integrated Circuit Card). The UICC is a smart card and allows a user when it is plugged into the user's mobile phone to use the mobile communication service that the user has subscribed to.

Parameters defined by the user and/or by the operator of the mobile communication network can be stored on the UICC. Further, operator-specific applications defined by the operator of the mobile communication network may be installed on the UICC. These applications can make use of the USAT (USIM application toolkit) which is an interface between the USIM (UMTS subscriber identity module) which is physically implemented by the UICC and the mobile equipment such that these applications can make use of the functionality of the mobile equipment, e.g. for sending an SMS (Short Message Service) message to the mobile communication network, playing a tone using the loudspeaker of the mobile equipment or displaying text or a graphical icon on the display of the mobile equipment.

With current mobile phones, it is possible to connect external devices such as a headset or other hardware such as a multimedia card (MMC) to a mobile phone. With future mobile phones it will probably be possible to connect other devices to a mobile phone, e.g. external displays, external monitors, loudspeakers, printers, scanners etc. by using connection mechanisms such as Bluetooth, USB (Universal Serial Bus) etc.

In case of a user equipment according to UMTS, the mobile equipment has the information which external devices are connected to the mobile equipment, but it is not known to the UICC of the UE and consequently not known by any application running on the UICC which devices are connected to the mobile equipment. When the UICC or an application running on the UICC does not have the information which devices are connected to the mobile equipment, the UICC or the application, respectively, cannot use the devices connected to the mobile equipment for any purpose.

### SUMMARY OF THE INVENTION

A radio communication device having a radio communication terminal and a chip card. The radio communication terminal has a generation unit generating device information which specifies for at least one device if the device is coupled to the radio communication terminal, and a transmitting unit transmitting the device information to the chip card.

Further, a method for controlling a chip card, a radio communication terminal, a chip card and a method for operating a chip card according to the radio communication device described above are provided.

### BRIEF DESCRIPTION OF THE FIGURES

Illustrative embodiments of the invention are explained below with reference to the drawings.

FIG. 1 shows a mobile radio user device according to an embodiment of the invention.

FIG. 2 shows a flow diagram according to an embodiment of the invention.

FIG. 3 shows a message flow diagram according to an embodiment of the invention.

FIG. 4 shows a device list structure according to an embodiment of the invention.

FIG. 5 shows a device list structure according to an embodiment of the invention.

FIG. 6 shows a flow diagram according to an embodiment of the invention.

FIG. 7 shows a message flow diagram according to an embodiment of the invention.

FIG. 8 shows a message flow diagram according to an embodiment of the invention.

FIG. 9 shows a radio communication device according to an embodiment of the invention.

### DETAILED DESCRIPTION OF THE INVENTION

Illustratively, the radio communication terminal sends the information to the chip card which devices are connected to the radio communication terminal, for example in the form of a list specifying all devices coupled to the radio communication terminal. This allows the chip card to determine which devices can be used by the chip card or by an application running on the chip card. Consequently, the chip card or an application running on the chip card can make full use of all devices connected to the radio communication terminal.

Embodiments of the invention emerge from the dependent claims. The embodiments which are described in the context of the radio communication device are analogously valid for the method for controlling a chip card, the radio communication terminal, the chip card and the method for operating a chip card.

The chip card may comprise a storing unit adapted to store the device information. The device information may be stored according to a list structure, which may have a device type structure, as in an embodiment described below.

The transmitting unit is configured to transmit the device information to the chip card when the radio communication terminal is switched on. The transmitting unit may also be configured to transmit the device information to the chip card when a device that has not been coupled to the radio communication terminal is coupled to the radio communication terminal or a device that has been coupled to the radio communication terminal is de-coupled from the radio communication terminal.

This means that the device information is transmitted to the chip card when the radio communication terminal is powered on and every time, that there is a change regarding the devices which are coupled to the radio communication terminal. Transferring the device information from the radio communication terminal to the chip card at terminal start up and when there is a change regarding the devices coupled to the radio communication terminal minimizes the traffic on the interface between the radio communication terminal and the chip card. Further, the device information as it is present in the chip card is always up to date and the chip card does not have to request the device information from the radio communication terminal when the chip card or an application running on the chip card wants to use a device.

The device information may further specify for at least one device that is coupled to the radio communication terminal parameters that are necessary to be known by the chip card or by an application running on the chip card for using the device.

The device information may also specify for at least one device that is coupled to the radio communication terminal a device priority that indicates a priority of the device based on which it is decided whether the device is used when at least a further device of the same type as the device is coupled to the radio communication terminal.

The radio communication terminal is for example a mobile phone. The radio communication device is for example a user equipment according to UMTS (Universal Mobile Telecommunications System) and the chip card is for example a UICC (Universal Integrated Circuit Card). The radio communication terminal may also be configured according to another radio communication standard like GSM (Global System for Mobile Communications) or CDMA2000 and the chip card may be a corresponding smart card, for example an SIM (Subscriber Identity module) card in case of GSM or an R-UIM in case of CDMA 2000.

The device information may be transmitted to the chip card using a CAT command, a SAT (SIM application toolkit) command, a USAT (USIM application toolkit; USIM: UMTS subscriber identity module) command, or a CCAT (CDMA application toolkit) command.

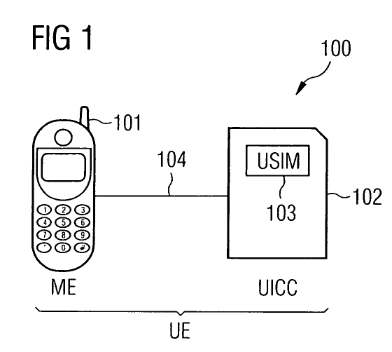

FIG. 1 shows a mobile radio user device 100 according to an embodiment of the invention.

The mobile radio user device 100 is a mobile radio user device according to the UMTS (Universal Mobile Telecommunications Service) standard, i.e., a so-called user equipment (UE). The mobile radio user device 100 consists of a mobile phone 101 (mobile equipment, ME) itself and further comprises a USIM (Universal Subscriber Identity Module) 103 which allows the usage of the mobile phone 101 in a UMTS mobile communication network. The USIM 103 represents a logical functionality and is implemented on a UICC (Universal Integrated Circuit Card) 102 which is a (physical) chip card (smart card).

By means of the USIM 103 data are stored which serve for the identification of the user of the mobile radio user device 100 when the mobile radio user device 100 is used in a mobile communication system and which are used to verify the authorization of the user to use a mobile communication service. Further, data are stored on the USIM 103 which allow encryption and decryption of data sent and received by means of the mobile radio user device 100.

Applications can be run on the UICC 102. These applications may be defined by the operator of the mobile communication system that the mobile radio user device 100 is used with. The applications can make use of an interface 104 between the mobile equipment 101 and the UICC 102, which in case of UMTS is provided by the so-called USAT (USIM application toolkit). By using the interface 104, the applications running on the UICC 102 can make use of functionalities of the mobile equipment 101, e.g. send text messages (like an SMS (Short Message Service) message), displaying a graphical icon on the display of the mobile equipment 101 or playing a tone using the loudspeaker of the mobile equipment 101.

Further, external devices such as a headset, an external display (like a monitor), loudspeakers, printers, scanners or other hardware such as a MMC (Multimedia Card) can be connected to the mobile equipment 101, e.g. by using connection mechanisms like USB (Universal Serial Bus) or wireless connection mechanisms, such as Bluetooth.

In the following, it is explained how the UICC 102 is provided with information about the devices (by devices, also other hardware such as a MMC is meant in the following) connected to the mobile equipment 101.

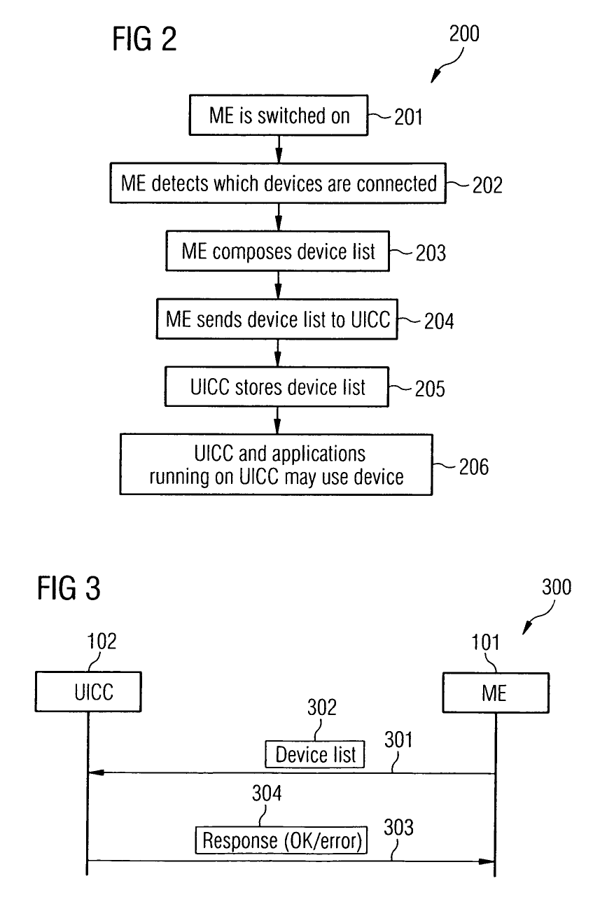

FIG. 2 shows a flow diagram 200 according to an embodiment of the invention.

In step 201, the mobile radio user device 100 is switched on by the user.

In step 202, the mobile equipment 101 detects which devices are connected to it.

In step 203, the mobile equipment 101 composes a device list, which contains an identification of all devices connected to the mobile equipment 101, parameter values or information related to the devices connected to the mobile equipment 101, which must be known by the UICC 102 or an application running on the UICC 102 in order to use the devices and priority information such that devices of the same type (e.g. all display devices or all printing devices) can be ordered according to their priorities.

In detail, the device list contains the following in this embodiment for each device connected to the mobile equipment 101:
The device ID: The device ID indicates the device type of the device. A device type is e.g. monitor (or display), printer, keyboard, MMC, loudspeaker, headset, scanner etc. The device ID may be used to group all devices connected to the mobile equipment 101 according to their device types.
The device name: The device name indicates a name of the device. The device names can e.g. be used to present all devices connected to the mobile equipment 101 to the user of the mobile radio user device 100
The priority of the device: The priority of the device indicates a priority that can be used to determine which device has highest priority when multiple devices of one device type are connected to the mobile equipment 101. The priority of the device is e.g. a numerical value and by comparing the numerical values corresponding to devices connected to the mobile equipment 101 of the same device type, the device of this device type with the highest priority can be determined which is e.g. the preferred device of this type and is to be used when one device of the device type should be used.
Device parameters: The device parameters specify information for the device that is necessary for the UICC 102 or an application running on the UICC 102 in order to use the device. This information may e.g. be:
   A specification by which connection mechanism the device is connected to the mobile equipment 101, e.g. USB, W-LAN (Wireless local area network), Bluetooth, etc.
   The version of the connection mechanisms, e.g. USB 2.0, etc.
   Drivers or driver information for using the device
   Specific information about the device, e.g. display resolution in case of a monitor or display device, type of a printer (colour or black/white) in case of a printing device, specification if a speaker is mono or stereo in case of a loudspeaker etc.

In step 204, the mobile equipment 101 transmits the device list to the UICC 102. This is illustrated in FIG. 3.

FIG. 3 shows a message flow diagram 300 according to an embodiment of the invention.

The message flow illustrated in FIG. 3 takes place between the UICC 102 and the mobile equipment 101.

In step 301, the mobile equipment 101 sends the device list in form of a device list message 302 to the UICC 102. This may e.g. be done by using a CAT (Card Application Toolkit) command “device list transfer” (or by a USAT command). The device list message 302 is in this embodiment sent to the UICC 102 in course of the UICC initialization procedure.

In step 303, the UICC 102 responds to the device list message 302 by transmitting a response message 304 to the mobile equipment 101. Using the response message 304, the UICC 102 specifies whether it has received the devise list correctly. Accordingly, the response message 304 is an error message or an OK message.

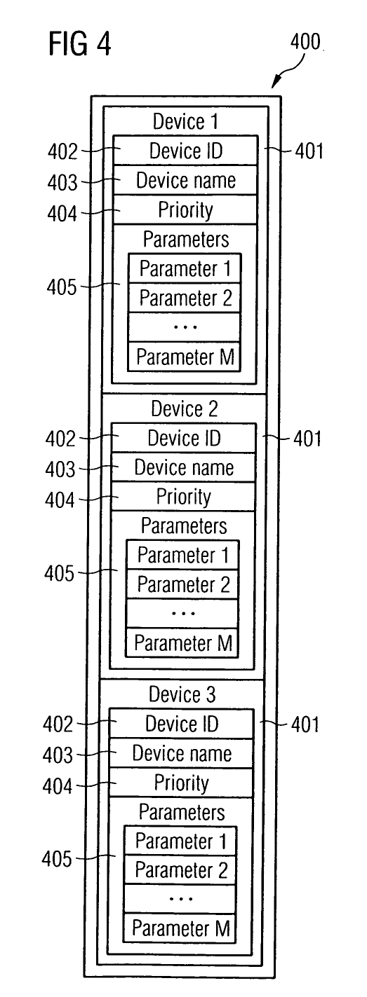

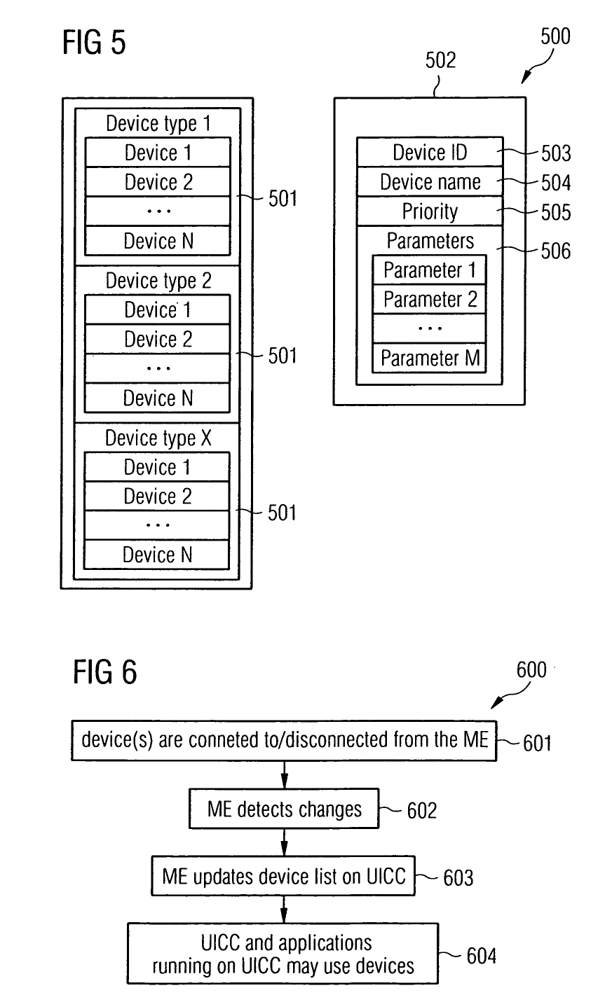

After reception of the device list, the device list is stored on the UICC 102 in step 205. In the following, two possible formats for storing the device list on the UICC 102 are explained with reference to FIGS. 4 and 5.

FIG. 4 shows a device list structure 400 according to an embodiment of the invention.

The device list structure 400 may be used as a storage format by the UICC 102 for storing the device list. The device list structure 400 has no device type structure in contrast to the device list structure described below with reference to FIG. 5.

According to the device list structure 400, there exists a device block 401 for each device in the device list (in this example it is assumed that N devices are connected to the mobile equipment 101). In each device block 401, the device ID 402, the device name 403, the device priority 404, and device specific parameters 405 of the corresponding device are stored.

The device list structure 400 can be used to store all the device list information and is especially useful when only one device per device type is connected to the mobile equipment 101 (e.g. only one printer and only one monitor are connected). When only one device for a device type is connected to the mobile equipment 101 and information about this device is stored in the device list, it is not necessary to store priority information about the device.

FIG. 5 shows a device list structure 500 according to an embodiment of the invention.

The device list structure 500 can be used alternatively to the device list structure 400 shown in FIG. 4 to store the device list information on the UICC 102. According to the device list structure 500, the information about the device list connected to the mobile equipment 101 is stored per device type. This means that for each device type there exists a device type block 501 (it is assumed that devices of X different device types are connected to the mobile equipment 101). A device type block 501 contains a device block 502 for each device of the corresponding device type. As above, a device block 502 corresponding to a device contains the device ID 503, the device name 504, the device priority 505, and device specific parameters 506.

For example, two printers are connected to the mobile equipment 101 and one device type block 501 corresponds to the device type “printer”. This device type block 501 contains a device block 502 for each of the two printers and each of these device blocks 502 contains the above-mentioned information about the respective printer.

In step 306, after the device list has been stored on the UICC, the UICC and applications running on the UICC may use the devices connected to the mobile equipment 101.

The UICC 102 or a software on the UICC 102 has the functionality to interpret the device list which is stored on the UICC 102. When the UICC 102 or an application running on the UICC 102 wants to use a specific device which can be connected to the mobile equipment 101, the UICC 102 (or the software running on the UICC providing this functionality) checks if the device to be used is listed in the device list. When the device is not listed in the device list, then the UICC 102 or the application running on the UICC 102 wanting to use the device gets the information that the device is currently not connected to the mobile equipment 101. When the device to be used is in the device list, then the UICC 102 or the application running on the UICC gets the information that the device is currently connected to the mobile equipment 101. In this case, the UICC 102 or the application running on the UICC 102 can easily use the device by using the information on the device stored in the device list, e.g. information on the connection mechanism by which the device is coupled to the mobile equipment 101.

To avoid the case that the device list as stored on the UICC 102 contains information about a device that is no longer connected to the mobile equipment 101 or lacks the information about a device which was additionally coupled to the mobile equipment 101 after the transmission of the device list at UICC initialization, the mobile equipment 101 updates the device list when there are changes regarding which devices (or which hardware) is connected to the mobile equipment 101. This is explained in the following with reference to FIG. 6.

FIG. 6 shows a flow diagram 600 according to an embodiment of the invention.

It is assumed that as explained above, a device list has been transmitted to the UICC 102 and has been stored thereon, for example in course of UICC initialization.

In step 601, a device or multiple devices are connected to or disconnected from the mobile equipment 101. This means that the device list is no longer up to date. Depending on whether a device or has been additionally coupled to the mobile equipment 101 and or a device has been disconnected from the mobile equipment 101, there may be a device listed in the device list that is no longer coupled to the mobile equipment 101 or they may be a device coupled to the mobile equipment 101 that is not listed in the device list.

In step 602, the mobile equipment 101 detects the changes regarding which devices are connected to the mobile equipment 101.

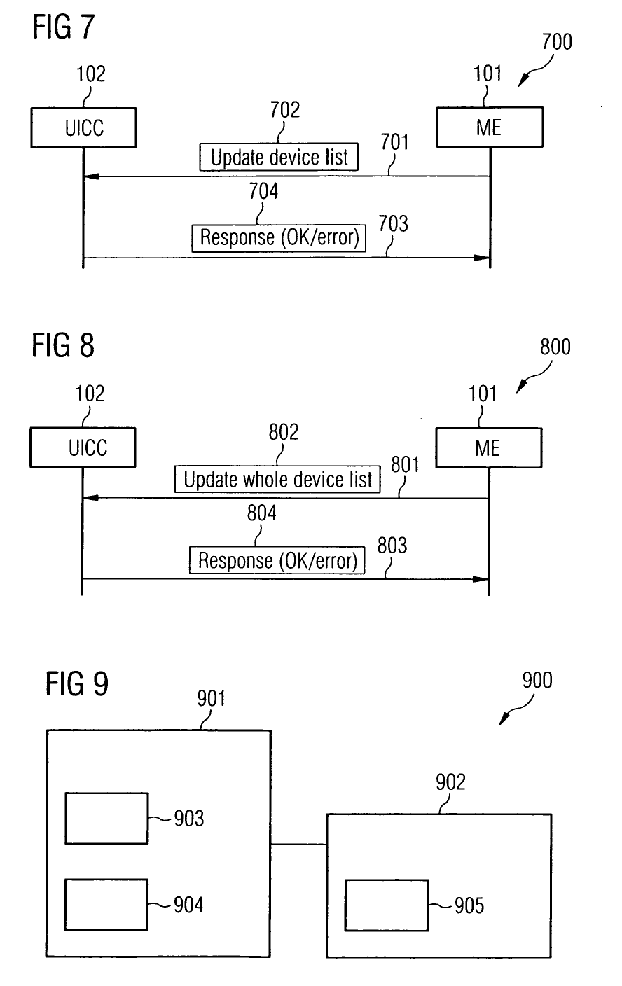

In step 603, the mobile equipment 101 updates the device list stored on the UICC 102. This can be done in two different ways which are explained with reference to FIGS. 7 and 8, respectively.

FIG. 7 shows a message flow diagram 700 according to an embodiment of the invention.

The message flow takes place between the UICC 102 and the mobile equipment 101.

According to this method for updating the device list stored in the UICC 102, the device list is updated when the mobile equipment 101 has detected that a device has newly been connected to the mobile equipment 101 with only information about this newly added device. Similarly, when a device is disconnected from the mobile equipment 101 and this has been detected by the mobile equipment 101 in step 602 the device list is updated by only deleting the information concerning the disconnected device from the device list.

When the mobile equipment 101 has detected that a device has been newly connected to the mobile equipment 101 or a device previously connected to the mobile equipment 101 has been disconnected from the mobile equipment 101, the mobile equipment sends, in step 701, an update device list message 702 to the UICC 102. The update device list message 702 may for example be transmitted to the UICC 102 according to a CAT command “Update device list”. The update device list message 702 contains the following information:
Update bit: This indicates if a device (i.e. the specification of a device and the information regarding the device) shall be deleted from the device list or added to the device list. When the update bit has the value 0, this means that a device from the device list shall be deleted; when the update bit has the value 1, this means that a device shall be added to the device list.
Information for updating the device list: In case that a device was disconnected from the mobile equipment 101, the information which device should be deleted from the device list on the UICC 102 is contained. In case that a device has been connected to the mobile equipment 101 and should be added to the device list on the UICC 102, the specification of the device and further information for the device (device name, priority, etc., see above) are contained.

Instead of the update device list message 702, in another embodiment, two separate messages may be used wherein one message is used when a device has been disconnected from the mobile equipment 101 and the device list should be updated accordingly and the other message is used when a device has been newly connected to the mobile equipment 101 and the device list should be updated accordingly.

After the update device list message 702 has been received by the UICC 102, the device list stored on the UICC 102 (as described above for example stored according to the device list structures shown in FIGS. 4 and 5) is updated according to the information contained in the update device list message 702.

The UICC 102 responds to the update device list message 702 in step 703 with a response message 704. When the update of the device list stored on the UICC 102 has gone wrong or when the update device list message 702 was not correctly received by the UICC 102 or in the case of another error, e.g. a device should be added to the device list and is already present in the device list or a device should be deleted from the device list and is not contained in the device list, the response message 704 is an error message. When no error has occurred and the device list stored on the UICC 102 has been updated correctly, the response message 704 is an OK message.

Alternatively, in case of changes regarding the devices connected to the mobile equipment 101, the whole device list (corrected according to the changes) is sent to the UICC 102 to replace the device list stored on the UICC. This is explained in the following with reference to FIG. 8.

FIG. 8 shows a message flow diagram 800 according to an embodiment of the invention.

The message flow takes place between the UICC 102 and the mobile equipment 101.

When a device has been disconnected from the mobile equipment 101 or a device is newly connected to the mobile equipment 101 and this has been detected by the mobile equipment 101 in step 602, the mobile equipment 101 sends an update whole device list message 802 in step 801 to the UICC 102. The update whole device list message 802 may for example be transmitted to the UICC 102 according to a CAT command “Update whole device list”. The update whole device list message 802 contains the device list generated by the mobile equipment 101 as explained above with reference to FIG. 2 (cf. step 203). When the UICC 102 has received the update whole device list message 802, the device list stored on the UICC 102 is replaced by the device list contained in the update whole device list message 802.

In step 803, the UICC 102 responds to the update whole device list message 802 by transmitting a response message 804 to the mobile equipment 101. When the update of the device list on the UICC 102 has gone wrong or when the update whole device list message 802 has not been correctly received by the UICC 102, then the response message 804 is an error message. When the device list stored on the UICC 102 has been updated correctly (i.e. has been correctly replaced) the response message 804 is an OK message.

When the device list stored on the UICC 102 has been properly updated in step 603, the UICC 102 and applications running on the UICC 102 may use the devices connected to the mobile equipment 101 in step 604, similar to step 206 of the flow shown in FIG. 2.

FIG. 9 shows a radio communication device 900 according to one embodiment of the invention.

The radio communication device 900 has a radio communication terminal 901 and a chip card 902, which is for example plugged into the communication terminal 901. The radio communication terminal 901 comprises a generation unit 903 which generates device information which specifies for at least one device if the at least one device is coupled to the radio communication terminal 901. Furthermore, the communication terminal 901 comprises a transmitting unit 904 which transmits the device information to the chip card 902. The chip card 902 for example comprises a receiving unit 905 which receives the device information.

What is claimed is:

1. A radio communication device having a radio communication terminal and a chip card, the radio communication terminal comprising:
a generation unit generating device information which specifies for at least one device if the at least one device is coupled to the radio communication terminal; and
a transmitting unit transmitting the device information to the chip card.

2. The radio communication device according to claim 1, wherein the chip card comprises a storing unit storing the device information.

3. The radio communication device according to claim 2, wherein the storing unit stores a device list structure comprising a device block for each device of the at least one device connected to the radio communication terminal.

4. The radio communication device according to claim 3, wherein the device block stores device priority information.

5. The radio communication device according to claim 2, wherein the storing unit stores a device list structure comprising a device type block for each device type connected to the radio communication terminal, and each device type block comprises a device block for each device of the corresponding device type.

6. The radio communication device according to claim 5, wherein each of the device blocks stores device priority information.

7. The radio communication device according to claim 1, wherein the transmitting unit transmits the device information to the chip card when the radio communication terminal is switched on.

8. The radio communication device according to claim 1, wherein the transmitting unit transmits the device information to the chip card when a device that has not been coupled to the radio communication terminal is coupled to the radio communication terminal or a device that has been coupled to the radio communication terminal is de-coupled from the radio communication terminal.

9. The radio communication device according to claim 1, wherein the device information further specifies for at least one device that is coupled to the radio communication terminal parameters that are necessary to be known by the chip card or by an application running on the chip card for using the device.

10. The radio communication device according to claim 9, wherein the parameters include at least one parameter selected from the group consisting of: a connection mechanism of the radio communication device and the radio communication terminal, driver information for the radio communication device, and radio communication device specific information.

11. The radio communication device according to claim 1, wherein the device information further specifies for at least one device that is coupled to the radio communication terminal a device priority that indicates a priority of the at least one device based on which it is decided whether the at least one device is used when at least a further device of the same type as the at least one device is coupled to the radio communication terminal.

12. The radio communication device according to claim 1, wherein the radio communication terminal is mobile phone.

13. The radio communication device according to claim 1, wherein the radio communication device is a user equipment according to UMTS and the chip card is a UICC.

14. The radio communication device according to claim 1, wherein the device information is transmitted to the chip card using a CAT command, a SAT command, a USAT command, or a CCAT command.

15. A method for controlling a chip card of a radio communication device, wherein the radio communication device includes a radio communication terminal and the chip card, the method comprising:
generating device information which specifies for at least one device if the at least one device is coupled to the radio communication terminal; and
transmitting the device information to the chip card.

16. A radio communication terminal, which can be coupled to a chip card, comprising:
a generation unit generating device information which specifies for at least one device if the at least one device is coupled to the radio communication terminal; and
a transmitting unit transmitting the device information to the chip card.

17. A chip card which can be coupled to a radio communication terminal, and which comprises a receiving unit receiving, from the radio communication terminal, device information which specifies for at least one device if the at least one device is coupled to the radio communication terminal.

18. A method for operating a chip card which can be coupled to a radio communication terminal, the method comprising receiving, from the radio communication terminal, device information which specifies for at least one device if the at least one device is coupled to the radio communication terminal.

19. A radio communication terminal, which can be coupled to a chip card, comprising:
a generation means for generating device information which specifies for at least one device if the at least one device is coupled to the radio communication terminal; and
a transmitting means for transmitting the device information to the chip card.

20. The radio communication device according to claim 19, wherein the chip card comprises a storing means for storing the device information.
